(19) United States
(12) Patent Application Publication
(10) Pub. No.: US 2005/0112239 A1
(43) Pub. Date: May 26, 2005

(54) Instant yogurt food product

(76) Inventors: Richard E. Rudin, Kenosha, WI (US); Dilip D. Kotecha, Racine, WI (US); Harish N. Kotecha, Cedar Park, TX (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 10/718,203

(22) Filed: Nov. 20, 2003

(51) Int. Cl. A23L 1/00

(52) U.S. Cl. 426/52

(57) ABSTRACT

An improved instant yogurt-like food product is formulated as a free-flowing dry food composition and is quickly reconstituted with a liquid by hand shaking. The food product can be formulated to be edible or drinkable. The composition includes at least one yogurt producing bacteria, a viscosity control agent, a cold water swelling starch, an edible acid, a sweetener, a flavoring agent and an edible salt. The composition can also include a prebiotic carbohydrate to create a synbiotic food product. The composition can be prepackaged and has a relatively long shelf life.

### FIELD OF THE INVENTION

This invention relates generally to yogurt and yogurt products. More specifically, it relates to an improved instant yogurt preparation that can be reconstituted using a liquid such as water or milk plus hand shaking or hand mixing. This invention also relates to an improved instant yogurt formulation that yields a product having smooth, yogurt-like texture and flavor. This invention also relates to an improved instant yogurt product that combines probiotic microorganisms with prebiotic carbohydrates to create a synbiotic food product, much like natural yogurt.

### BACKGROUND OF THE INVENTION

Yogurt is a form of fermented milk that has been curdled or coagulated to give a smooth, creamy or custard-like consistency. Natural yogurt is produced by introducing a beneficial bacteria mixture of Streptococcus thermophilus and Lataobacillus bulgaricus in milk and allowing the micro-organisms to incubate until the proper acidity level is established in the milk. This mixture is then chilled to reduce the activity of the cultures and to control its final acidity. Because natural yogurt is an active mixture containing active micro-organisms, it must be chilled to prevent further incubation which will eventually spoil the product. For this reason, yogurt containing active cultures can be quite costly and must be consumed relatively shortly after production and prior to its expiration date.

The texture of yogurt is also an important factor in determining its acceptability. The yogurt should be free of lumps and curds and should exhibit a smooth, custard-like, creamy consistency. There have been several attempts to prepare dried products that can be reconstituted to form an acceptable yogurt-like product, i.e. so-called “instant” yogurt. One prior instant yogurt food product is disclosed and claimed in U.S. Pat. No. 4,624,853 issued to Rudin. In that product, a free-flowing dry food composition of at least one yogurt-producing bacteria, a viscosity control agent, an encapsulated starch agent with an emulsifier, edible acid, sweetener, dry edible oil, flavoring agent and salt is reconstituted, without heating, into a yogurt-like product by shaking the composition with fresh milk or water. Emulsification of the starch in such a product is desireable for the reason that, without the encapsulated starch, the resulting food product would tend to be gummy or end up with dried powder clumps throughout or an accumulation of un-dissolved powder at the bottom of the mixing container. Emulsification is, however, an added process in the formulation of the starch and includes an element of added cost to the overall product. Similarly, without the edible oil, the resulting food product as disclosed by the prior art would lack appropriate body and the creamy mouth-feel of natural fresh yogurt. A more simple formulation that would eliminate the need to use an emulsifier with the starch gelling agent and that would eliminate the edible oil from the formulation would also need to compensate for product quality in the absence of those components.

In the view of these inventors, the healthful benefits of the cultures contained in natural yogurt should also be available in their instant yogurt counterparts. For example, it is known that gastrointestinal health can be enhanced through the introduction of certain prebiotic carbohydrates into the diet. Inulin, a natural dietary fiber, is one such prebiotic that increases the activity of live active cultures and helps to prevent the growth of harmful bacteria in the digestive tract. That is, inulin enhances the probiotic cultures in the intestinal tract which helps the body defend itself more effectively against food-borne illnesses. Inulin has also been shown to boost calcium absorption in the body and to promote good digestive health through the production of other vitamins and enzymes. Accordingly, an instant yogurt product would be improved by the introduction of a suitable prebiotic into the formulation.

### SUMMARY OF THE INVENTION

Accordingly, it is an object of the present invention to provide an improved instant yogurt product that uses a fewer number of different components in the formulation, and that specifically eliminates the need to use a starch emulsifier and edible oil in the formulation.

It is therefore one object of the present invention to provide an improved composition that can be added quickly and easily to a liquid such as milk or water to form an instant yogurt product.

It is another object of the present invention to provide an improved instant yogurt product that has the taste and mouth feel characteristics of a natural yogurt product.

It is still another object of the present invention to provide an improved composition that can be reconstituted into a yogurt product with a minimum of agitation such as by moderate hand shaking or hand mixing and without heating or mechanical agitation.

It is yet a further object of the present invention to provide such an improved instant yogurt product that includes the healthful properties of natural yogurt and promotes the growth of probiotic bacteria following ingestion by including a dosage of prebiotic carbohydrate.

It is yet another object of the present invention to provide an improved instant yogurt product that can be prepackaged within one or more individual packages and that has a relatively long shelf life, on the order of one to two years.

It is still another object of the present invention to provide an improved yogurt drink composition that can be quickly and easily prepared from a dry mix.

It is yet another object of the present invention to provide an improved yogurt pie filling composition that can be quickly and easily prepared from a dry mix.

The improved instant yogurt composition of the present invention has obtained these objects. The improved instant yogurt product is formulated to be prepared by mixing, with a liquid such as milk or water, a composition comprising from about 0.005 to 10% by weight of at least one yogurt producing bacteria; from about 0.05 to 20% by weight of a viscosity control agent; from about 4 to 60% by weight of a starch; sufficient acid to produce a pH of from about 3.7 to 4.7; from about 10 to 90% by weight of a sweetener; from about 0.1 to 25% by weight of a flavoring agent; and from about 0.1 to 3% by weight of a salt. The improved instant yogurt product can also include a prebiotics dosage of from about 0.5 to 35% by weight. The improved composition can be added quickly and easily to a liquid such as milk or water to form an instant yogurt product. It can be reconstituted into a yogurt-like product with a minimum of agitation such as by shaking or hand mixing and without heating or mechanical agitation. The improved instant yogurt product that has the taste and mouth feel characteristics of a natural yogurt product while using a fewer number of different components in the formulation. The improved composition also includes the healthful properties of natural yogurt and promotes the growth of probiotic bacteria following ingestion by means of a dosage of prebiotic carbohydrate into the formulation. Further objects and advantages of the composition of the present invention will become apparent from the detailed description that follows.

### DETAILED DESCRIPTION OF THE INVENTION

The improved instant yogurt food product of the present invention, which food product is readily reconstituted by mixing with a liquid, comprises from about 0.005 to 10% by weight of at least one yogurt producing bacteria; from about 0.05 to 20% by weight of a viscosity control agent; from about 4 to 60% by weight of a starch; sufficient edible acid to produce a pH of from about 3.7 to 4.7; from about 10 to 90% by weight of a sweetener; from about 0.1 to 25% by weight of a flavoring agent; and from about 0.1 to 3% by weight of a salt.

The compositions of the present invention include at least one yogurt producing bacteria. In the preferred formulation, at least two yogurt producing bacteria are included. These yogurt producing bacterias are selected from yogurt cultures which may contain Lactobacillus bulgaricus, Streptococcus thermophilus, and Lactobacillus acidophilus as well as other yogurt cultures and mixtures. These bacterias are available as dry cultures and can be either used in a spray-dried, freeze-dried, or encapsulated form. The bacteria Lactobacillus acidophilus may be included in natural fermented yogurt as a digestion aid for lactose intolerant consumers.

These bacteria also serve as probiotics. Probiotics are living microbiological dietary supplements that have beneficial effects to the consumer through their function in the digestive tract. To insure effectiveness as a probiotic, such microorganisms must be able to survive the digestive conditions, including bile acids, and must be able to colonize the gastrointestinal tract with natural beneficial bacteria. To obtain sufficient live bacteria when ingested and to promote the growth of beneficial intestinal bacteria similar to that produced by natural yogurts, bacteria counts from about 1×10⁵ to about 1×10⁹ microorganisms per typical eight ounce serving should be used. The amount of culture may vary widely depending on its concentration and viability. Typically from about 0.005 to 10% by weight of dried culture is incorporated into the dry mix, preferably from about 0.1 to 5% and most preferably from about 0.15 to 1.0% dried material is used.

Natural yogurt is also known to be a synbiotic food. That is, it combines certain nondigestible carbohydrates, also known as prebiotics, with living microbiological dietary supplements that have the beneficial gastrointestinal effects as previously alluded to. Certain nondigestible carbohydrates, such as components of certain soluble dietary fibers, are known to stimulate the growth or activity of the beneficial probiotic bacteria. Such components in food are called prebiotics and can occur naturally in food or can be specific supplements to it. The composition of the present invention also includes, in the preferred embodiment, at least one prebiotic carbohydrate. Prebiotics generally fall into one of three different categories of fructooligosaccharides, or FOS. FOS are chain polymers of the sugar fructose that are found in a variety of foods. The sugar units can be linked in a single straight chain or can be a chain with side branches. Chemically, FOS is difficult to define because the length of the fructose chains can vary from source to source. First, there are short chain fructooligosaccharides, or scFOS, which promote the growth of probiotic intestinal bacteria. Next, there is a long chain FOS of which inulin is a variety. Inulin is also known for its ability to hold water, thereby replacing fat and contributing minimal calories to the formulation. A number of healthful side effects have also been associated with the ingestion of inulin, including the increase in the level of beneficial cultures in the intestinal tract, the decrease in the level of harmful bacteria, including those that cause food-borne illnesses such as E. coli, Salmonella, Staphylococcus and Listeria, and boosting calcium absorption. Lastly, there is oligofructose, also known as oligosaccharide, which has a different fermentation profile. Oligofructose has been proffered as an agent that is detrimental to the development of known carcinogens in the digestive tract. The shorter compounds with lower molecular weight tend to have a sweet taste. Thus, the size and complexity of the FOS chain gives it certain desirable characteristics. For example, the simple sugars fructose and glucose are quickly absorbed by the intestines. The FOS, on the other hand, are largely indigestible and act as a non-digestible fiber in the diet. The principal reason for this is that humans do not have the necessary enzymes to break down the FOS as they travel through the digestive tract. Exactly how the FOS exert their beneficial effects is not certain. However, increasing numbers of beneficial bacteria in the lower intestine, changes in the pH level of the intestinal contents, and increases in enzyme levels that are thought to be related to the detoxification of carcinogens in the diet, have all been cited as reasons to increase the FOS levels in the diet. In the preferred embodiment, the prebiotics dosage included per an eight ounce serving is generally 1 to 15 gm. or 0.5 to 35% by weight of the yogurt mix, preferably 2 to 5 gm. or 4 to 14% by weight of the yogurt mix, and optimally 3 to 5 gm. or 6 to 14% by weight of the yogurt mix.

The second component in the improved composition of the present invention is a viscosity control agent. A suitable viscosity agent is KELTROL® 521, a food grade xanthan gum manufactured by CP Kelco. Other gums such as guar gum, carrageenan, sodium alginates and locust bean gum are also suitable for use as viscosity control agents. Without a suitable viscosity agent, the resulting food product would tend to experience increased syneresis, or weeping of the liquid component from the gelatinous food product during alteration such as by spooning. The amount of viscosity control agent used in the product can vary widely depending on the other components present in the composition. Typical products will include from about 0.05 to 20% viscosity control agent while it is preferred that about 0.1 to 5% be present and optimally from about 0.2 to about 3% viscosity control agent be present.

The next major component in the improved composition of the present invention is an instant starch. By use of the appropriate instant starch, proper viscosity and mouth-feel of the composition when it has been reconstituted with a liquid will occur. Suitable instant starches must be quick-setting, be re-hydrated rapidly, and have a bland flavor. Use of the instant starches must provide an improved instant yogurt food product that can be quickly reconstituted with liquid by minimal mixing by shaking or stirring. In the experience of these inventors, the preferred instant starch is a cold water swelling (CWS) starch, which is a term used to describe granular instant starches that swell in cold systems to develop viscosity. The CWS is typically extracted from cereals selected from the group consisting of maize or corn, wheat or rice, or from roots or tubers selected from the group consisting of tapioca and potato, or mixtures thereof. The major advantage of using the CWS starch in the improved instant yogurt product of the present invention is the fact that no starch emulsifier needs to be added to the starch and the use of edible oil can be avoided. This greatly simplifies the formulation and reduces the manufacturing and processing costs associated with the formulation. Examples of suitable CWS starches include MIRA THIK® 470 starch manufactured by A.E. Staley Co., a high viscosity, modified food starch derived from dent corn, or field corn; and a variety of C* HIForm brand modified starches manufactured by Cerestar/Cargill Company, also derived from waxy maize or tapioca starch. Although the use of MIRA THIK® 470 starch is preferred, it is possible that other CWS starches can be incorporated in the composition of the present invention. Depending on the other components present in the composition of the present invention, the amount of CWS starch will vary widely. Generally, however, from about 4 to 60% by weight of the starch should be present in the dry product while it is preferable to use from about 5 to 30% by weight starch and optimally from about 10 to 25% by weight starch.

The composition of the present invention also includes sufficient edible acid to produce pH control. Suitable acids include citric acid, malic acid, whey acids, lactic acids, etc., and mixtures. The preferred acids are the malic and citric acids although other acids may be used. These acids provide the tart, tangy taste that is typical of yogurt and should be used in amounts sufficient to lower the pH to in the range of from about 3.7 to 4.7 to give the typical acidic flavor of yogurt. Depending on the acids utilized and the other materials present in the composition, generally from about 2 to 30% and preferably from about 5 to 20% by weight of acid should be present in the dry composition.

The composition also includes a sufficient amount of a sweetener. Either natural and/or synthetic sweeteners can be utilized, such as sugars, fructose, Splenda®, aspartame, dextrose, lactose, etc. Also, artificial sweeteners can be utilized either in whole or in part as a sweetener such as sodium saccharin, etc. The preferred sweetener is a combination of sucrose and dextrose. Typically, the amount of sweetener can vary widely, however, generally, from about 10 to 90% by weight sweetener and preferably from about 25 to 75% by weight and optimally from about 30 to 70% sweetener is incorporated. This level will be much lower when using a sweetener such as aspartame or Splenda®.

The compositions of the present invention also should include a flavoring agent. These flavoring agents include liquid, plated and spray dried yogurt flavors and fruit flavors. Although the yogurt food product of the present invention has many of the characteristics of yogurt, it does not have the identical taste characteristics of yogurt and flavoring agents simulating yogurt flavoring should be added accordingly. Also, it has been found that many people prefer yogurt having other flavorings such as a variety of berries, orange, apricot, peach, pineapple, and many other fruits, and dairy flavorings such as chocolate and butterscotch. Typically, these flavorings can be added in either liquid or dried form or in the form of vacuum dried, freeze dried, or puree dried starch fruit bits. Typical freeze dried fruit powders and bits are those supplied in a variety of fruit flavors by Quest International. The amount of flavoring in the present composition can vary from about 0.1 to 25% by weight, preferably from about 0.3 to 15% by weight and optimally from about 1 to 4% by weight.

The compositions of the present invention also include a small amount of edible salt such as sodium chloride or potassium chloride. Suitable edible salts include flake salt, a screened, fine compacted, food grade, vacuum evaporated sodium chloride, and ALBERGER® SHUR-FLO® fine flour salt, a natural crystalline, fine sodium chloride, both manufactured by Cargill Salt. Generally from about 0.1 to 3% by weight of this edible salt should be present in the composition and preferably from about 0.1 to 1%. The salt is added in a small amount to enhance the overall flavor and acceptability of the yogurt product.

In addition to the above components, the compositions of the present invention include a wide variety of other materials. These materials include buffering agents, vitamins, minerals, artificial colorants, dietary fibers, appetite suppressants to help persons who are on reduced intake diets, lactose to help persons who have difficulty digesting milk products, desiccants in order to keep the powder free flowing, preservatives and the like. Generally these materials should be present in amounts less that 5% by weight of the total composition and should be used in amounts so as not to adversely affect the overall taste, appearance and acceptability of the final yogurt food product.

One additional optional ingredient that can be incorporated into the composition is a dry milk-type material. By the term “dry milk-type materials” is meant both dairy and non-dairy milk products and/or milk replacers. Examples of such dry milk-type materials include dried powdered milk, dried whey, dry non-dairy milk substitutes, etc. including mixtures. One embodiment of the improved instant yogurt product of the present invention is a “one-step” process which requires that the product be reconstituted by adding milk to the dried material to reconstitute the product. A second embodiment is a “two-step” process which involves incorporating dry milk-type materials into the product so that a milk-type product can first be reconstituted using only water. The improved instant yogurt product is then added to this reconstituted milk-type product to then, in turn, reconstitute the instant yogurt product to its final edible form. Furthermore, some dry milk-type material can also be incorporated into the product which is designed to be reconstituted using milk so as to provide a creamier final yogurt product. Although not absolutely essential to the composition of the present invention, it has been found appropriate to incorporate from about 1 to 80% by weight of dry milk-type material and typically from about 10 to 60% and optimally from about 15 to 50% to the dried product mix.

The compositions of the present invention can be prepared in a simple manner by essentially dry blending most of the components together. Where those materials to be added to the composition in the present invention are liquids, they should be sprayed or misted over the dry components during the blending process.

The compositions of the present invention should be packaged in sealed envelopes or pouches such that they will exclude air and moisture. Furthermore, the packages may also optimally be purged with nitrogen to exclude any oxygen so as to extend the culture shelf life at ordinary temperatures. Pre-packaging individual serving amounts is also preferred, and enables the consumer to easily use either the “one-step” or the “two-step” reconstitution processes referred to above. That is, in the “two-step” process, the dry milk-type materials are incorporated into a first package and the balance of the dry instant yogurt product materials are incorporated into a second package. For reconstitution, the contents of the first package are added to a prescribed amount of water and shaken for 10 to 20 seconds. Then the contents of the second package are added to the liquid mix and shaken for another 10 to 20 seconds. The combined liquid mix is allowed to set for about 2 minutes prior to consumption. In the “one-step” process, the single blended dry mix is added to water and shaken for 10 to 20 seconds, then allowed to set for about 2 minutes prior to consumption. The single blended dry mix can also be formulated for reconstitution with cold milk using the same steps. As an aid to the end consumer, a dish or cup can be provided as part of the product kit and the dish or cup includes a fill line for the consumer's easy addition of a quantity of milk or water to the composition prior to reconstitution.

Another significant feature of the improved instant yogurt product of the present invention is that the dry materials as formulated by these inventors are essentially non-perishable. The shelf life of the dry materials is one to two years.

The composition of the present invention will now be illustrated by the following examples which are for the purpose of illustration only and are not in any way to be considered as limiting. In the following examples, all parts and percentages are by weight.

### EXAMPLE I

The following improved primary formulation was prepared by dry blending the following ingredients as the contents of a first package:

| Ingredients | Percentage |
|---|---|
| Sugar | 43.77 |
| Dextrose | 26.24 |
| Xanthan Gum | 0.49 |
| Citric Acid | 1.17 |
| Malic Acid | 4.47 |
| Sodium Citrate | 0.29 |
| Sodium Chloride | 0.58 |
| CWS Starch | 17.03 |
| Dairy Flavor | 1.46 |
| Fruit Flavor | 1.95 |
| Fruit Flakes/Bits | 2.43 |
| Yogurt Cultures | 0.01 |
| Lactobacillus acidophilus | 0.11 |
| | 100.00% |

The following secondary formulation was also prepared by dry blending the following as the contents of a second package:

| Ingredients | Percentage |
|---|---|
| Non-Fat Milk Powder | 95.09 |
| Whole Milk Powder | 4.91 |
| | 100.00% |

In this example, 22 grams of the second package was mixed with 165 ml. of cold water by hand shaking for 10 to 20 seconds. Next, 37 grams of the first package was then added to this mixture and blended by hand shaking for another 10 to 20 seconds followed by resting for 2 minutes. This produced an instant yogurt product that has good yogurt-like appearance and taste characteristics. In this example, the contents of the first package can also be mixed with fresh milk to produce an instant yogurt product.

### EXAMPLE II

The following improved instant yogurt formulation was prepared by dry blending the following ingredients:

| Ingredients | Percentage |
|---|---|
| Sugar | 27.46 |
| Dextrose | 16.41 |
| Xanthan Gum | 0.31 |
| Citric Acid | 0.73 |
| Malic Acid | 2.80 |
| Sodium Citrate | 0.19 |
| Sodium Chloride | 0.37 |
| CWS Starch | 10.68 |
| Dairy Flavor | 0.92 |
| Fruit Flavor | 1.22 |
| Fruit Flakes/Bits | 1.53 |
| Yogurt Cultures | 0.02 |
| Lactobacillus acidophilus | 0.07 |
| Non-Fat Milk Powder | 35.46 |
| Whole Milk Powder | 1.83 |
| | 100.00% |

In this example, 59 grams of this formulation was mixed with 165 ml. of cold water by hand shaking for 10 to 20 seconds followed by resting for 2 minutes. This produced an instant yogurt product that has good yogurt-like appearance and taste characteristics.

### EXAMPLE III

The following improved instant yogurt formulation was prepared by dry blending the following ingredients:

| Ingredients | Percentage |
|---|---|
| Sugar | 42.81 |
| Dextrose | 23.97 |
| Xanthan Gum | 0.40 |
| Citric Acid | 2.22 |
| Malic Acid | 5.47 |
| Sodium Citrate | 0.38 |
| Sodium Chloride | 0.68 |
| CWS Starch | 21.33 |
| Dairy Flavor | 0.62 |
| Fruit Flavor | 0.62 |
| Fruit Flakes/Bits | 1.33 |
| Yogurt Cultures | 0.02 |
| Lactobacillus acidophilus | 0.15 |
| | 100.00% |

In this example, 23 grams of this formulation was mixed with 180 ml. of fresh milk by hand shaking for 10 to 20 seconds followed by resting for 2 minutes. This produced an instant yogurt product that has good yogurt-like appearance and taste characteristics.

### EXAMPLE IV

The following improved formulation produced an instant yogurt drink and was prepared by dry blending the following ingredients:

| Ingredients | Percentage |
|---|---|
| Sugar | 46.00 |
| Dextrose | 26.28 |
| Xanthan Gum | 0.46 |
| Citric Acid | 2.44 |
| Malic Acid | 6.00 |
| Sodium Citrate | 0.41 |
| Sodium Chloride | 0.75 |
| CWS Starch | 14.64 |
| Dairy Flavor | 0.69 |
| Fruit Flavor | 0.69 |
| Fruit Flakes/Bits | 1.46 |
| Yogurt Cultures | 0.02 |
| Lactobacillus acidophilus | 0.16 |
| | 100.00% |

In this example, 20.5 grams of this formulation was mixed with 180 ml. of fresh milk by hand shaking for 10 to 20 seconds. This formulation forms a yogurt product having a thick mixture suitable for consumption as an instant yogurt drink.

### EXAMPLE V

The following improved instant yogurt formulation contains prebiotic cultures and was prepared by dry blending the following ingredients:

| Ingredients | Percentage |
|---|---|
| Sugar | 41.43 |
| Dextrose | 23.45 |
| Xanthan Gum | 0.39 |
| Citric Acid | 2.17 |
| Malic Acid | 5.35 |
| Sodium Citrate | 0.39 |
| Sodium Chloride | 0.65 |
| CWS Starch | 22.61 |
| Dairy Flavor | 0.61 |
| Fruit Flavor | 0.61 |
| Fruit Flakes/Bits | 1.30 |
| Yogurt Cultures | 0.02 |
| Prebiotics Culture | 0.87 |
| Lactobacillus acidophilus | 0.15 |
| | 100.00% |

In this example, 23 grams of this formulation was mixed with 180 ml. of fresh milk by hand shaking for 10 to 20 seconds followed by resting for 2 minutes. This produced an instant yogurt product that has good yogurt-like appearance and taste characteristics.

### EXAMPLE VI

The following improved yogurt pie filling formulation was prepared by dry blending the following ingredients:

| Ingredients | Percentage |
|---|---|
| Sugar | 39.96 |
| Dextrose | 23.03 |
| Xanthan Gum | 0.39 |
| Citric Acid | 2.07 |
| Malic Acid | 5.10 |
| Sodium Citrate | 0.36 |
| Sodium Chloride | 0.63 |
| CWS Starch | 25.90 |
| Dairy Flavor | 0.58 |
| Fruit Flavor | 0.58 |
| Fruit Flakes/Bits | 1.24 |
| Yogurt Cultures | 0.02 |
| Lactobacillus acidophilus | 0.14 |
| | 100.00% |

In this example, 67 grams of this formulation was mixed with 500 ml. of fresh milk by simple hand mixing for 20 to 30 seconds. This mixture was then placed in a pie crust shell, followed by refrigeration until the filling has reached a desired firmness.

### EXAMPLE VII

The following improved sugar free instant yogurt formulation was prepared by dry blending the following ingredients:

| Ingredients | Percentage |
|---|---|
| Splenda ® | 5.50 |
| Maltodextrin | 55.10 |
| Xanthan Gum | 0.45 |
| Citric Acid | 2.50 |
| Malic Acid | 6.15 |
| Sodium Citrate | 0.45 |
| Sodium Chloride | 0.74 |
| CWS Starch | 26.00 |
| Dairy Flavor | 0.70 |
| Fruit Flavor | 0.70 |
| Fruit Flakes/Bits | 1.50 |
| Yogurt Cultures | 0.03 |
| Lactobacillus acidophilus | 0.18 |
| | 100.00% |

In this example, 20 grams of this improved formulation was shaken with 180 ml. of fresh milk, a sugar free yogurt product was obtained.

1. An improved free-flowing dry food composition to be reconstituted into a yogurt-like product by mixing with liquid comprising from about 0.005 to 10% by weight of at least one yogurt producing bacteria;
from about 0.05 to 20% by weight of a viscosity control agent selected from the group consisting of a gum or a mixture of gums;
from about 4 to 60% by weight of a cold water swelling starch extracted from cereals selected from the group consisting of maize or corn, wheat or rice, or from roots or tubers selected from the group consisting of tapioca and potato, and mixtures thereof;
sufficient edible acid to produce a pH of from about 3.7 to 4.7;
from about 10 to 90% by weight of a sweetener;
from about 0.1 to 25% by weight of at least one flavoring agent; and
from about 0.1 to 3% by weight of an edible salt.

2. The improved composition of claim 1 wherein the yogurt producing bacteria is selected from the group consisting of Lactobacillus bulgaricus, Streptococcus thermophilus, Lactobacillus acidophilus, and mixtures thereof.

3. The improved composition of claim 1 wherein the acid is selected from the group consisting of citric acid, malic acid, whey acid, lactic acid and mixtures thereof.

4. The improved composition of claim 1 wherein the composition additionally includes from about 0.5 to 35% by weight of a prebiotic carbohydrate.

5. The improved composition of claim 4 wherein the prebiotic carbohydrate is selected from the group consisting of a short chain fructooligosaccharide, a long chain fructooligosaccharide, oligofructose, and mixtures thereof.

6. The improved composition of claim 5 wherein the long chain fructooligosaccharide is inulin.

7. The improved composition of claim 1 wherein the composition additionally includes not more than 5% by weight of additional additives from the group consisting of buffering agents, vitamins, minerals, artificial sweeteners, artificial colorants, dietary fibers, appetite suppressants, lactose, desiccants, preservatives, dry milk materials, dry milk replacers, and mixtures thereof.

8. The improved composition of claim 1 wherein reconstitution of the composition is accomplished by hand shaking of the composition with the liquid.

9. The improved composition of claim 8 wherein the liquid is milk.

10. The improved composition of claim 1 wherein the composition is pre-packaged within a single package.

11. The improved composition of claim 10 wherein the package is sealed to provide long shelf life of the composition.

12. The improved composition of claim 1 wherein the composition additionally includes from about 1 to 80% by weight of a dry material selected from the group consisting of dairy milk products, non-dairy milk products, milk replacers and mixtures thereof.

13. The improved composition of claim 12 wherein reconstitution of the composition is accomplished by hand shaking of the composition with the liquid.

14. The improved composition of claim 13 wherein the liquid is water.

15. The improved composition of claim 12 wherein the composition is pre-packaged as the contents of a single package.

16. The improved composition of claim 15 wherein reconstitution of the composition is accomplished by mixing the contents of the package with the liquid and by hand shaking thereof.

17. The improved composition of claim 16 wherein the liquid is water.

18. The improved composition of claim 15 wherein the package is sealed to provide long shelf life of the contents.

19. The improved composition of claim 12 wherein that portion of the composition comprising at least one yogurt producing bacteria, a viscosity control agent, a cold water swelling starch, an edible acid, a sweetener, at least one flavoring agent, and an edible salt is pre-packaged as the contents of a first package and that portion of the composition comprising the dry milk or milk replacers is pre-packaged as the contents of a second package.

20. The improved composition of claim 19 wherein reconstitution of the composition is accomplished by mixing the contents of the second package with the liquid and by hand shaking thereof, and by then mixing the contents of the first package therewith and by continued hand shaking thereof.

21. The improved composition of claim 20 wherein the first and second packages are sealed to provide long shelf life of the contents of each package.

22. The improved composition of claim 21 wherein the liquid is water.

23. The improved composition of claim 1 wherein the dry food composition is reconstituted into an instant yogurt drink.

24. The improved composition of claim 1 wherein the dry food composition is reconstituted into an instant yogurt pie filling.
